(19) United States
(12) Patent Application Publication
(10) Pub. No.: US 2025/0306264 A1
(43) Pub. Date: Oct. 2, 2025

(54) MULTIMODE OPTICAL FIBER

(71) Applicant: CORNING INCORPORATED, CORNING, NY (US)

(72) Inventors: Scott Robertson Bickham, Corning, NY (US); Adrian Alejando Juarez Marroquin, Wellsboro, PA (US); Snigdharaj Kumar Mishra, Wilmington, NC (US); Simit Mayank Patel, Greensboro, NC (US)

(21) Appl. No.: 19/086,205

(22) Filed: Mar. 21, 2025

Related U.S. Application Data
(60) Provisional application No. 63/570,385, filed on Mar. 27, 2024.

(51) Int. Cl. G02B 6/028

(52) U.S. Cl. CPC G02B 6/0288; G02B 6/0281

(57) ABSTRACT

A multimode optical fiber may include a core and a trench region. The core may include a radius R₁ that is greater than or equal to 23 μm and less than or equal to 27 μm and a graded index having an alpha value that is greater than or equal to 1.9 and less than or equal to 2.2. The trench region may include a triangular relative refractive index profile. The trench region may include at least one portion within which a relative refractive index delta percent of the trench region decreases with increasing radius. The trench region may include a trench volume V₃ ranging from −100%-microns² to −170%-microns².

### CROSS REFERENCE TO RELATED APPLICATION

This application claims the benefit of priority under 35 U.S.C. § 119 of U.S. Provisional Application Ser. No. 63/570,385 filed on Mar. 27, 2024, the content of which is relied upon and incorporated herein by reference in its entirety.

### BACKGROUND

Aspects of the present disclosure relate to optical fiber, and more particularly to multimode optical fibers.

Fiber designs with an index trench, such as fluorine-doped index trench, have been proposed as one approach to make multimode bend-insensitive fibers. Bend-insensitive multimode fibers are attractive for many applications, including data center applications. There is always a demand for new fiber designs that demonstrates improved bend performance without sacrificing other performance characteristics and/or that can be manufactured with simpler processes to lower production costs.

### SUMMARY

In some embodiments, a multimode optical fiber may include a core, a trench, and a transition region disposed between the core and the trench region. In some embodiments, the core may include a radius R₁ that may be greater than or equal to 23 μm and less than or equal to 27 μm, and a graded index having an alpha value that may be greater than or equal to 1.9 and less than or equal to 2.2. In some embodiments, the trench region may include a triangular relative refractive index profile, and at least one portion of the trench region within which a relative refractive index delta percent may continuously decrease with increasing radius. In some embodiments, the trench region may include a trench volume V₃ ranging from −100%-microns² to −170%-microns². In some embodiments, the alpha value of the transition region may be different from the alpha value of the core. In some embodiments, the alpha value of the transition region may be different from the alpha value of the at least one portion of the trench region. In some embodiments, a minimum calculated effective modal bandwidth (minEMBc) of the multimode optical fiber at 850 nm may be greater than or equal to 4.0 GHz-km. In some embodiments, an overfilled (OFL) bandwidth of the multimode optical fiber at 850 nm may be greater than or equal to 3.0 GHz-km.

In some embodiments, a multimode optical fiber may include a core, a trench region, and a transition region disposed between the core and the trench region. In some embodiments, the core may include a radius R₁ that may be greater than or equal to 23 μm and less than or equal to 27 μm, and a graded index having an alpha value that may be greater than or equal to 1.9 and less than or equal to 2.2. In some embodiments, the trench region may include at least one portion within which a relative refractive index delta percent of the trench region may continuously decrease in a substantially linear manner. In some embodiments, the trench region may include a trench volume V₃ ranging from −100%-microns² to −170%-microns². In some embodiments, the alpha value of the transition region may be different from the alpha value of the core. In some embodiments, the alpha value of the transition region may be different from the alpha value of the at least one portion of the trench region. In some embodiments, the transition region may include an alpha value greater than or equal to 0.7 and less than or equal to 1.7.

In some embodiments, a multimode optical fiber, may include a core and a trench region. In some embodiments, the core may include a radius R₁ that may be greater than or equal to 23 μm and less than or equal to 27 μm, and a graded index having an alpha value that may be greater than or equal to 1.9 and less than or equal to 2.2. In some embodiments, the trench region may include a triangular relative refractive index profile having at least one portion within which a relative refractive index delta percent of the trench region may decrease linearly with increasing radius. In some embodiments, the trench region may include a trench volume V₃ ranging from −100%-microns² to −170%-microns². In some embodiments, a minimum calculated effective modal bandwidth (minEMBc) of the multimode optical fiber at 850 nm may be greater than or equal to 4.0 GHz-km. In some embodiments, an overfilled (OFL) bandwidth of the multimode optical fiber at 850 nm may be greater than or equal to 3.0 GHz-km.

Additional features and advantages will be set forth in the detailed description which follows, and in part will be readily apparent to those skilled in the art from the description or recognized by practicing the embodiments as described in the written description and claims hereof, as well as the appended drawings.

### BRIEF DESCRIPTION OF THE DRAWINGS

The accompanying drawings are included to provide a further understanding and are incorporated in and constitute a part of this specification. The drawings illustrate one or more embodiment(s), and together with the detailed description serve to explain principles and operation of the various embodiments. As such, the disclosure will become more fully understood from the following detailed description, taken in conjunction with the accompanying figures.

FIG. 1 is a schematic representation (not to scale) of a cross-sectional view of a multimode optical fiber, according to some embodiments.

FIG. 2 shows a schematic representation (not to scale) of a relative refractive index profile of a multimode optical fiber, according to some embodiments.

FIG. 3 shows relative refractive index profiles of exemplary multimode optical fibers, according to some embodiments.

FIG. 4 shows a relative refractive index profile of another exemplary multimode optical fiber, according to some embodiments.

FIG. 5 shows a relative refractive index profile of another exemplary multimode optical fiber, according to some embodiments.

FIG. 6 shows a relative refractive index profile of another exemplary multimode optical fiber, according to some embodiments.

FIG. 7 shows relative refractive index profiles of further exemplary multimode optical fibers, according to some embodiments.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this detailed description.

In this document, relational terms, such as first and second, top and bottom, and the like, are used to distinguish one entity or action from another entity or action, without necessarily requiring or implying any actual such relationship or order between such entities or actions.

It will be understood by one having ordinary skill in the art that construction of the described apparatus and/or components is not limited to any specific material. Exemplary embodiments disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The “refractive index profile” or “relative refractive index profile” is the relationship between refractive index or relative refractive index and waveguide fiber radius.

The “relative refractive index delta precent” is defined as:

$${Δ}_{i} ( {r}_{i} ) \% = 100 \frac{( {n}_{i}^{2} - {n}_{ref}^{2} )}{2 {n}_{i}^{2}}$$

where nᵢ is the refractive index at radial position rᵢ in the glass fiber, unless otherwise specified. The terms 4%, delta, delta %, and delta percent are used herein interchangeably and all represent relative refractive index delta percent. Unless otherwise specified, the reference index, n_{REF} is referred to herein as the average refractive index of the refractive index profile over radial positions extending from 88 to 96% of the fiber diameter, i.e., over radial positions between 55.0 and 60.0 microns for a fiber diameter of 125 microns. If this annulus is comprised of undoped silica, the refractive index n_{ref} will be 1.4525 at 850 nm, but higher refractive index values may be obtained if the cladding is updoped, for example, via doping with chlorine, titanium, phosphorus, germania or an alternative updoping material. The refractive index of silica at different wavelengths is well-known. See for example, S. Kobayashi, S. Shibata, and T. Izawa, “Refractive-Index Dispersion of Doped Fused Silica,” in International Conference on Integrated Optics and Optical Fiber Communication, Tokyo, (1977). The change in the refractive index of silica when it is doped with Germania and/or Fluorine is also well-known. See for example, J. Fleming, “Dispersion in GeO₂—SiO₂ glasses,” Appl. Opt. 23, pp. 4486-4493 (December 1984). The refractive index profile of an optical fiber may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nmeas, where the measurement reference index nmeas is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween.

Macrobend performance can be determined according to FOTP-62 (IEC-60793-1-47) by wrapping 1 or other predetermined number of turns around either a 6 mm, 10 mm, 15 mm, 20 mm, 30 mm diameter mandrel or other suitably sized mandrel (e.g. “1×10 mm diameter macrobend loss” or the “1×20 mm diameter macrobend loss”) and measuring the increase in attenuation due to the bending using an encircled flux (EF) launch condition. The encircled flux can be obtained by launching an overfilled pulse into an input end of a 2 m length of InfiniCor® 50 μm optical fiber which is deployed with a 1×25 mm diameter mandrel near the midpoint. The output end of the InfiniCor® 50 μm optical fiber is spliced to the fiber under test, and the measured bend loss is the ratio of the attenuation under the prescribed bend condition to the attenuation without the bend. The overfilled bandwidth can be measured according to FOTP-204 using an overfilled launch. The minimum calculated effective modal bandwidth (minEMBc) bandwidths can be obtained from measured differential mode delay spectra as specified by TIA/EIA-455-220.

The numerical aperture of the fiber means numerical aperture as measured using the method set forth in TIA SP3-2839-URV2 FOTP-177 IEC-60793-1-43 titled “Measurement Methods and Test Procedures-Numerical Aperture”.

The optical core diameter can be measured using the technique set forth in IEC 60793-1-20, titled “Measurement Methods and Test Procedures-Fiber Geometry”, in particular using the reference test method outlined in Annex C thereof titled “Method C: Near-field Light Distribution.”

The term “α-profile” or “alpha profile” refers to a relative refractive index profile Δ(r) that has the following functional form:

$$Δ ( r ) = Δ ( {r}_{0} ) [ 1 - {[ \frac{\vert r - {r}_{0} \vert}{( {r}_{z} - {r}_{0} )} ]}^{α} ]$$

where r₀ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number. Δ(r₀) for an α-profile may be referred to herein as Amax or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁ of the core region, and Δ₁(r₁)=0, the above equation simplifies to:

$${Δ}_{1} ( r ) = {Δ}_{1 ma x} [ 1 - {[ \frac{r}{{r}_{1}} ]}^{α} ]$$

When the core region has an alpha profile as described above, the outer radius r₁ can be determined from the measured relative refractive index profile by the following procedure. Estimated values of the maximum relative refractive index Δ₁ₘₐₓ, α, and outer radius rₗₑₛₜ are obtained from inspection of the measured relative refractive index profile and used to create a trial function Δₜᵣᵢₐₗ between r=−rₗₑₛₜ and r=rₗₑₛₜ. The sum of the squares of the difference between the trial function and the measured profile (Δₘₑₐₛ), χ²=Σ(Δₜᵣᵢₐₗ−Δₘₑₐₛ)², is minimized over values of r ranging between 0.1rₗₑₛₜ and 0.95rₗₑₛₜ using the Nelder-Mead algorithm (Nelder, John A. and R. Mead, “A simplex method for function minimization”. Computer Journal 7:308-313 (1965)) to determine Δ₁ₘₐₓ, α, and r₁.

Embodiments of multimode optical fibers described herein may include a graded index core and a triangular trench region. In some embodiments, the multimode optical fiber may further include a transition region at the interface of the graded index core and the trench region. In some embodiments, the core may include a radius R₁ that may be greater than or equal to 23 μm and less than or equal to 27 μm, and a graded index having an alpha value that may be greater than or equal to 1.9 and less than or equal to 2.2. In some embodiments, the trench region may include a triangular relative refractive index profile. In some embodiments, the trench region may include at least one portion within which a relative refractive index delta percent may continuously decrease with increasing radial position from the fiber centerline, such as continuously decrease in a linear manner. In some embodiments, the trench region may include a trench volume V₃ ranging from −100%-microns² to −170%-microns².

The multimode optical fiber described herein may exhibit excellent bend performance while still enabling high modal bandwidth. For example, the multimode optical fiber may exhibit a 2×15 mm diameter mandrel wrap attenuation increase of less than or equal to 0.1 dB/turn at 850 nm, and a 2×15 mm diameter mandrel wrap attenuation increase of less than or equal to 0.3 dB/turn at 1310 nm. At the same time, in some embodiments, a minimum calculated effective modal bandwidth (minEMBc) of the multimode optical fiber at 850 nm may be greater than or equal to 4.0 GHz-km, and an overfilled (OFL) bandwidth of the multimode optical fiber at 850 nm may be greater than or equal to 3.0 GHz-km.

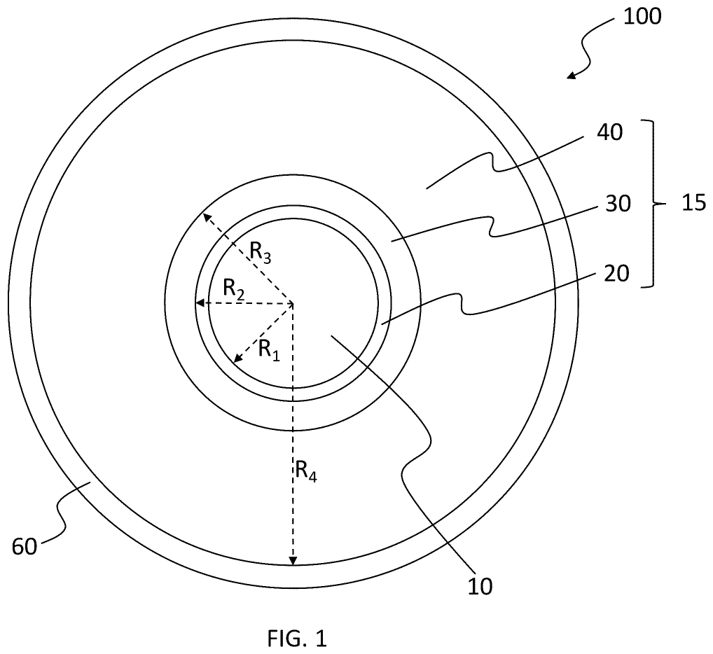

FIG. 1 is a schematic representation (not to scale) of a cross-sectional view of a multimode optical fiber 100, according to some embodiments. The multimode optical fiber 100 may include a core (or glass core) 10 and a cladding (or glass cladding) 15. The cladding 15 may include a trench region 30 and an outer cladding region 40. In some embodiments, the trench region 30 may be offset, or spaced away, from the core 10 by a transition region 20. The transition region 20 may surround and directly contact the core 10. The trench region 30 may surround and directly contact the transition region 20. The outer cladding region 40 may surround and directly contact the trench region 30. The outer cladding region 40 and/or the cladding 15 may be surrounded by and may directly contact a coating 60. The coating 60, in some instances, may include a low modulus primary coating and a high modulus secondary coating.

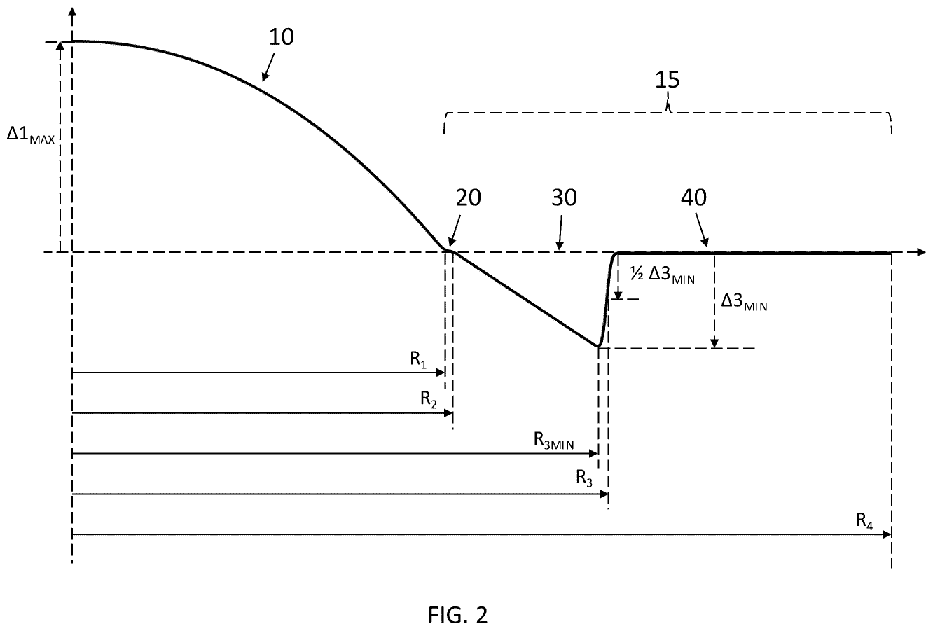

FIG. 2 shows a schematic representation (not to scale) of the relative refractive index profile of a cross-section of the glass region (core 10 and cladding 15) of the multimode optical fiber 100, according to some embodiments. The core 10 may include a relative refractive index profile Δ1(r). The transition region 20 may include a relative refractive index profile Δ2(r). The trench region 30 may include a relative refractive index profile Δ3(r). The outer cladding region 40 may include a relative refractive index profile Δ4(r). In some embodiments, Δ1(r)>Δ3(r), and Δ3(r)<Δ4(r). In some embodiments, Δ1(r)>Δ2(r)>Δ3(r), and Δ3(r)<Δ4(r).

In some embodiments, the core 10 may be a graded index core. In some embodiments, the relative refractive index profile Δ1(r) of the core 10 may have a parabolic, or substantially parabolic, shape. The alpha value of the relative refractive index profile Δ1(r) of the core 10 may be greater than or equal to 1.9 and less than or equal to 2.2—including all sub-ranges or values therebetween. For example, in some embodiments, the alpha value of the relative refractive index profile Δ1(r) of the core 10 may be greater than or equal to 1.9 and less than or equal to 2.2, greater than or equal to 1.9 and less than or equal to 2.15, greater than or equal to 1.9 and less than or equal to 2.1, greater than or equal to 1.9 and less than or equal to 2.05, greater than or equal to 1.9 and less than or equal to 2.0, greater than or equal to 2.0 and less than or equal to 2.2, greater than or equal to 2.0 and less than or equal to 2.15, greater than or equal to 2.0 and less than or equal to 2.1, greater than or equal to 2.0 and less than or equal to 2.05, greater than or equal to 2.05 and less than or equal to 2.2, greater than or equal to 2.05 and less than or equal to 2.15, greater than or equal to 2.05 and less than or equal to 2.1, greater than or equal to 2.1 and less than or equal to 2.2, greater than or equal to 2.1 and less than or equal to 2.15, or greater than or equal to 2.15 and less than or equal to 2.2.

The relative refractive index profile Δ1(r) of the core 10, and thus, the alpha value thereof, may be adjusted or controlled such that the multimode optical fiber 100 may be optimized for use at different wavelengths. In some embodiments, when optimized for use at a wavelength range from about 840 nm to about 870 nm, such as about 850 nm, the alpha value of the relative refractive index profile Δ1(r) of the core 10 may be greater than or equal to 2.10 and less than or equal to 2.14—including all sub-ranges or values therebetween. For example, when optimized for use at the wavelength range from about 840 nm to about 870 nm, such as about 850 nm, the alpha value of the relative refractive index profile Δ1(r) of the core 10 may be greater than or equal to 2.10 and less than or equal to 2.14, greater than or equal to 2.10 and less than or equal to 2.13, greater than or equal to 2.10 and less than or equal to 2.12, greater than or equal to 2.10 and less than or equal to 2.11, greater than or equal to 2.11 and less than or equal to 2.14, greater than or equal to 2.11 and less than or equal to 2.13, greater than or equal to 2.11 and less than or equal to 2.12, greater than or equal to 2.12 and less than or equal to 2.14, greater than or equal to 2.12 and less than or equal to 2.13, or greater than or equal to 2.13 and less than or equal to 2.14.

In some embodiments, when optimized for use at about 1060 nm, the alpha value of the relative refractive index profile Δ1(r) of the core 10 may be greater than or equal to 2.04 and less than or equal to 2.08—including all sub-ranges or values therebetween. For example, in some embodiments, when optimized for use at about 1060 nm, the alpha value of the relative refractive index profile Δ1(r) of the core 10 may be greater than or equal to 2.04 and less than or equal to 2.08, greater than or equal to 2.04 and less than or equal to 2.07, greater than or equal to 2.04 and less than or equal to 2.06, greater than or equal to 2.04 and less than or equal to 2.05, greater than or equal to 2.05 and less than or equal to 2.08, greater than or equal to 2.05 and less than or equal to 2.07, greater than or equal to 2.05 and less than or equal to 2.06, greater than or equal to 2.06 and less than or equal to 2.08, greater than or equal to 2.06 and less than or equal to 2.07, or greater than or equal to 2.07 and less than or equal to 2.08.

In some embodiments, when optimized for use at about 1310 nm, the alpha value of the relative refractive index profile Δ1(r) of the core 10 may be greater than or equal to 2.00 and less than or equal to 2.04—including all sub-ranges or values therebetween. For example, in some embodiments, when optimized for use at about 1310 nm, the alpha value of the relative refractive index profile Δ1(r) of the core 10 may be greater than or equal to 2.00 and less than or equal to 2.04, greater than or equal to 2.00 and less than or equal to 2.03, greater than or equal to 2.00 and less than or equal to 2.02, greater than or equal to 2.00 and less than or equal to 2.01, greater than or equal to 2.01 and less than or equal to 2.04, greater than or equal to 2.01 and less than or equal to 2.03, greater than or equal to 2.01 and less than or equal to 2.02, greater than or equal to 2.02 and less than or equal to 2.04, greater than or equal to 2.02 and less than or equal to 2.03, or greater than or equal to 2.03 and less than or equal to 2.04.

The core 10 may include an outer radius R₁. The outer radius R₁ of the core 10 may be greater than or equal to 23 μm and less than or equal to 27 Δm—including all sub-ranges or values therebetween. For example, in some embodiments, the outer radius R₁ of the core 10 may be greater than or equal to 23 μm and less than or equal to 27 μm, greater than or equal to 23 μm and less than or equal to 26 μm, greater than or equal to 23 μm and less than or equal to 25 μm, greater than or equal to 23 μm and less than or equal to 24 μm, greater than or equal to 24 μm and less than or equal to 27 μm, greater than or equal to 24 μm and less than or equal to 26 μm, greater than or equal to 24 μm and less than or equal to 25 μm, greater than or equal to 25 μm and less than or equal to 27 μm, greater than or equal to 25 μm and less than or equal to 26 μm, or greater than or equal to 26 μm and less than or equal to 27 μm.

In some embodiments, the relative refractive index profile Δ1(r) of the core 10 may not be negative, where Δ1(r)≥0%. In some embodiments, the relative refractive index profile Δ1(r) of the core 10 may include an entirely positive relative refractive index profile, where Δ1(r)>0%. The relative refractive index profile Δ1(r) of the core 10 may have a maximum relative refractive index delta percent Δ1_{MAX}. In some embodiments, the core 10 may have the maximum relative refractive index delta percent Δ1_{MAX} at the centerline of the multimode optical fiber 100, or radial position R=0. In some embodiments, the maximum relative refractive index delta percent Δ1_{MAX} of the core 10 may be greater than or equal to 0.6% and less than or equal to 1.4%-including all sub-ranges or values therebetween. For example, in some embodiments, the maximum relative refractive index delta percent Δ1_{MAX} of the core 10 may be greater than or equal to 0.6% and less than or equal to 1.4%, greater than or equal to 0.6% and less than or equal to 1.2%, greater than or equal to 0.6% and less than or equal to 1.0%, greater than or equal to 0.6% and less than or equal to 0.8%, greater than or equal to 0.8% and less than or equal to 1.4%, greater than or equal to 0.8% and less than or equal to 1.2%, greater than or equal to 0.8% and less than or equal to 1.0%, greater than or equal to 1.0% and less than or equal to 1.4%, greater than or equal to 1.0% and less than or equal to 1.2%, or greater than or equal to 1.2% and less than or equal to 1.4%.

In some embodiments, the core 10 may include silica doped with germanium, such as germania doped silica. Dopants other than germanium such as Al₂O₃ or P₂O₅, singly or in combination, may be employed within the core, and particularly at or near the centerline of the multimode optical fiber 100, to obtain the desired refractive index and density. In some embodiments, the optical fiber contains no index-decreasing dopants, such as fluorine, in the core.

In some embodiments, the relative refractive index profile Δ3(r) of the trench region 30 may not be positive, where Δ3(r)≤0%. In some embodiments, the trench region 30 may include an entirely negative relative refractive index profile, where Δ3(r)<0%.

The trench region 30 may include an inner radius R₂ and an outer radius R₃. In some embodiments, the trench region 30 may decreases monotonically from the inner radius R₂ to the outer radius R₃. Thus, in some embodiments, the relative refractive index delta percent Δ3(r) of the trench region 30 may become more negative with increasing radius. In some embodiments, the monotonic decrease in the relative refractive index profile Δ3(r) of the trench region 30 may exhibit a constant or approximately constant slope. In other words, the relative refractive index profile Δ3(r) may decrease linearly with increasing radius. In such embodiments, the trench region 30 is referred to as a triangular trench. In some embodiments, the monotonic decrease in the relative refractive index profile Δ3(r) of the trench region 30 may extend from a maximum value Δ3_{MAX} at or near the inner radius R₂ to a minimum value Δ3_{MIN} at or near outer radius R₃. The maximum relative refractive index delta percent Δ3_{MAX} of the trench region 30 may be greater than or equal to −0.10% and less than or equal to 0.10%, greater than or equal to −0.05% and less than or equal to 0.05%, or greater than or equal to −0.02% and less than or equal to 0.02%. The minimum relative refractive index delta percent Δ3_{MIN} of the trench region 30 may be in the range from −0.60% to −0.10%-including all sub-ranges or values therebetween.

The inner radius R₂ of the trench region 30 corresponds to the radial position at which the relative refractive index delta percent first becomes negative. The outer radius R₃ of the trench region 30 corresponds to the radial position R₃ at which the relative refractive index delta percent equals to half of the minimum refractive index value Δ3_{MIN} as discussed in more detail below. As discussed above, the trench region 30 may have a continuously decreasing relative refractive index delta percent from radial position R₂ until the minimum relative refractive index delta percent Δ3_{MIN} is reached. In some embodiments, the minimum relative refractive index delta percent Δ3_{MIN} may be first reached at radius RΔ3_{MIN}. In some embodiments, within the entire trench region 30, the relative refractive index delta percent may continuously decrease from the inner radius R₂ of the trench region 30 to the outer radius R₃ of the trench region 30. For example, in some embodiments, within the entire trench region 30, the relative refractive index delta percent may continuously decrease in a linear manner from the inner radius R₂ of the trench region 30 to the outer radius R₃ of the trench region 30. In these embodiments, radial position RΔ3_{MIN} may coincide or substantially coincide with radial position R₃, and there may be a step change (or vertical change) from the minimum relative refractive index delta percent Δ3_{MIN} to the relative refractive index profile Δ4(r) of the outer cladding region 40. In some embodiments, the change from the minimum relative refractive index delta percent Δ3_{MIN} to the relative refractive index profile Δ4(r) may not be a step or vertical change. In these embodiments, the outer radius R₃ of the trench region 30 or radial position R₃ corresponds to the radial position where the relative refractive index delta percent is equal to ½ Δ3_{MIN} when the relative refractive index delta percent increases from the minimum relative refractive index delta percent Δ3_{MIN} to the relative refractive index profile Δ4(r) of the outer cladding region 40.

In some embodiments, the inner radius R₂ of the trench region 30 may be greater than or equal to 23 μm and less than or equal to 27 Δm-including all sub-ranges or values therebetween. For example, in some embodiments, the inner radius R₂ of the trench region 30 may be greater than or equal to 23 μm and less than or equal to 27 μm, greater than or equal to 23 μm and less than or equal to 26 μm, greater than or equal to 23 μm and less than or equal to 25 μm, greater than or equal to 23 μm and less than or equal to 24 μm, greater than or equal to 24 μm and less than or equal to 27 μm, greater than or equal to 24 μm and less than or equal to 26 μm, greater than or equal to 24 μm and less than or equal to 25 μm, greater than or equal to 25 μm and less than or equal to 27 μm, greater than or equal to 25 μm and less than or equal to 26 μm, or greater than or equal to 26 μm and less than or equal to 27 μm.

In some embodiments, the outer radius R₃ of the trench region 30 may be greater than or equal to 33 μm and less than or equal to 37 Δm-including all sub-ranges or values therebetween. For example, in some embodiments, the outer radius R₃ of the trench region 30 may be greater than or equal to 33 μm and less than or equal to 37 μm, greater than or equal to 33 μm and less than or equal to 36 μm, greater than or equal to 33 μm and less than or equal to 35 μm, greater than or equal to 33 μm and less than or equal to 34 μm, greater than or equal to 34 μm and less than or equal to 37 μm, greater than or equal to 34 μm and less than or equal to 36 μm, greater than or equal to 34 μm and less than or equal to 35 μm, greater than or equal to 35 μm and less than or equal to 37 μm, greater than or equal to 35 μm and less than or equal to 36 μm, or greater than or equal to 36 μm and less than or equal to 37 μm.

The radius RΔ3_{MIN} at which the minimum relative refractive index delta percent Δ3_{MIN} is reached may be greater than or equal to 33 μm and less than or equal to 37 Δm-including all sub-ranges or values therebetween. For example, in some embodiments, the radius RΔ3_{MIN} may be greater than or equal to 33 μm and less than or equal to 37 μm, greater than or equal to 33 μm and less than or equal to 36 μm, greater than or equal to 33 μm and less than or equal to 35 μm, greater than or equal to 33 μm and less than or equal to 34 μm, greater than or equal to 34 μm and less than or equal to 37 μm, greater than or equal to 34 μm and less than or equal to 36 μm, greater than or equal to 34 μm and less than or equal to 35 μm, greater than or equal to 35 μm and less than or equal to 37 μm, greater than or equal to 35 μm and less than or equal to 36 μm, or greater than or equal to 36 μm and less than or equal to 37 μm.

A difference between R₃ and RΔ3_{MIN}, i.e., R₃-RΔ3_{MIN}, may be less than or equal to 3 μm, less than or equal to 2 μm, less than or equal to 1.5 μm, less than or equal to 1 μm, less than or equal to 0.5 μm, or about or equal to 0 μm.

The alpha value of at least the portion of the relative refractive index profile Δ3(r) from radial position R₂ to radial position RΔ3_{MIN}, or the alpha value of the entire relative refractive index profile Δ3(r) within the trench region from radial position R₂ to radial position R₃ when RΔ3_{MIN} and R₃ overlap, may be greater than or equal to 0.8 and less than or equal to 1.2—including all sub-ranges or values therebetween. For example, in some embodiments, the alpha value of the relative refractive index profile Δ3(r) from radial position R₂ to radial position RΔ3_{MIN} (or from radial position R₂ to radial position R₃ when RΔ3_{MIN} and R₃ overlap or substantially overlap) may be greater than or equal to 0.8 and less than or equal to 1.2, greater than or equal to 0.8 and less than or equal to 1.1, greater than or equal to 0.8 and less than or equal to 1.0, greater than or equal to 0.8 and less than or equal to 0.9, greater than or equal to 0.9 and less than or equal to 1.2, greater than or equal to 0.9 and less than or equal to 1.1, greater than or equal to 0.9 and less than or equal to 1.0, greater than or equal to 1.0 and less than or equal to 1.2, greater than or equal to 1.0 and less than or equal to 1.1, or greater than or equal to 1.1 and less than or equal to 1.2. In some embodiments, the alpha value of the relative refractive index profile Δ3(r) from radial position R₂ to radial position RΔ3_{MIN} (or from radial position R₂ to radial position R₃ when RΔ3_{MIN} and R₃ overlap or substantially overlap) may be about 1.2, about 1.1, about 1.0, about 0.9, or about 0.8.

The minimum relative refractive index delta percent Δ3_{MIN} of the trench region 30 may be greater than or equal to −0.6% and less than or equal to −0.1%-including all sub-ranges or values therebetween. For example, in some embodiments, the minimum relative refractive index delta percent Δ3_{MIN} may be greater than or equal to −0.6% and less than or equal to −0.1%, greater than or equal to −0.6% and less than or equal to −0.2%, greater than or equal to −0.6% and less than or equal to −0.3%, greater than or equal to −0.6% and less than or equal to −0.35%, greater than or equal to −0.6% and less than or equal to −0.4%, greater than or equal to −0.6% and less than or equal to −0.45%, greater than or equal to −0.6% and less than or equal to −0.5%, greater than or equal to −0.6% and less than or equal to −0.55%, greater than or equal to −0.55% and less than or equal to −0.1%, greater than or equal to −0.55% and less than or equal to −0.2%, greater than or equal to −0.55% and less than or equal to −0.3%, greater than or equal to −0.55% and less than or equal to −0.35%, greater than or equal to −0.55% and less than or equal to −0.4%, greater than or equal to −0.55% and less than or equal to −0.45%, greater than or equal to −0.55% and less than or equal to −0.5%, greater than or equal to −0.5% and less than or equal to −0.1%, greater than or equal to −0.5% and less than or equal to −0.2%, greater than or equal to −0.5% and less than or equal to −0.3%, greater than or equal to −0.5% and less than or equal to −0.35%, greater than or equal to −0.5% and less than or equal to −0.4%, greater than or equal to −0.5% and less than or equal to −0.45%, greater than or equal to −0.45% and less than or equal to −0.1%, greater than or equal to −0.45% and less than or equal to −0.2%, greater than or equal to −0.45% and less than or equal to −0.3%, greater than or equal to −0.45% and less than or equal to −0.35%, greater than or equal to −0.45% and less than or equal to −0.4%, greater than or equal to −0.4% and less than or equal to −0.1%, greater than or equal to −0.4% and less than or equal to −0.2%, greater than or equal to −0.4% and less than or equal to −0.3%, greater than or equal to −0.4% and less than or equal to −0.35%, greater than or equal to −0.35% and less than or equal to −0.1%, greater than or equal to −0.35% and less than or equal to −0.2%, greater than or equal to −0.35% and less than or equal to −0.3%, greater than or equal to −0.3% and less than or equal to −0.1%, greater than or equal to −0.3% and less than or equal to −0.2%, or greater than or equal to −0.2% and less than or equal to −0.1%.

The trench region 30 may have a trench volume V₃ defined as follows and given in units of percent delta micron square (%-microns²):

V₃=2∫_{R2}^{R3}Δ₃(r)rdr

where R₂ is the inner radius of the trench region 30, R₃ is the outer radius of the trench region 30, →3(r) is the relative refractive index of the trench region 30 of the refractive index profile, and r is radial position in the fiber.

In some embodiments, the trench volume V₃ of the trench region 30 may range from −100%-microns² to −170%-microns², from −110%-microns² to −170%-microns², from −100%-microns² to −140%-microns², or from −110%-microns² to −140%-microns².

The trench volume V₃ of the trench region 30 may be adjusted or controlled such that the multimode optical fiber 100 may achieve superior bend loss performance at various wavelengths. In some embodiments, to achieve desired bend loss performance for use at a wavelength range from about 840 nm to about 870 nm, such as about 850 nm, the trench volume V₃ of the trench region 30 may range from −100%-microns² to −170%-microns², from −110%-microns² to −170%-microns², from −120%-microns² to −170%-microns², from −130%-microns² to −170%-microns², from −140%-microns² to −170%-microns², from −150%-microns² to −170%-microns², from −160%-microns² to −170%-microns², from −100%-microns² to −160%-microns², from −110%-microns² to −160%-microns², from −120%-microns² to −160%-microns², from −130%-microns² to −160%-microns², from −140%-microns² to −160%-microns², from −150%-microns² to −160%-microns², from −100%-microns² to −150%-microns², from −110%-microns² to −150%-microns², from −120%-microns² to −150%-microns², from −130%-microns² to −150%-microns², from −140%-microns² to −150%-microns², from −100%-microns² to −140%-microns², from −110%-microns² to −140%-microns², from −120%-microns² to −140%-microns², from −130%-microns² to −140%-microns², from −100%-microns² to −130%-microns², from −110%-microns² to −130%-microns², from −120%-microns² to −130%-microns², from −100%-microns² to −120%-microns², from −100%-microns² to −110%-microns², or from −110%-microns² to −120%-microns².

In some embodiments, to achieve desired bend loss performance for use at about 1060 nm, the trench volume V₃ of the trench region 30 may range from −100%-microns² to −140%-microns², from −110%-microns² to −140%-microns², from −120%-microns² to −140%-microns², from −130%-microns² to −140%-microns², from −100%-microns² to −130%-microns², from −110%-microns² to −130%-microns², from −120%-microns² to −130%-microns², from −100%-microns² to −120%-microns², from −100%-microns² to −110%-microns², or from −110%-microns² to −120%-microns².

In some embodiments, to achieve desired bend loss performance for use at about 1310 nm, the trench volume V₃ of the trench region 30 may range from −100%-microns² to −140%-microns², from −110%-microns² to −140%-microns², from −120%-microns² to −140%-microns², from −130%-microns² to −140%-microns², from −100%-microns² to −130%-microns², from −110%-microns² to −130%-microns², from −120%-microns² to −130%-microns², from −100%-microns² to −120%-microns², from −100%-microns² to −110%-microns², or from −110%-microns² to −120%-microns².

In some embodiments, the trench region 30 may include silica doped with one or more down dopants. Exemplary down dopants may include fluorine, boron, non-periodic voids, etc.

In some embodiments, the transition region 20, disposed between the core 10 and the trench region 30, may be defined as the region between the radial position from which the relative refractive index profile deviates from the alpha profile of the core 10 and the inner radius R₂ of the trench region 30. Accordingly, in some embodiments, the alpha value of the transition region 20 may be different from the alpha value of the core 10. In some embodiments, the alpha value of the transition region 20 may be different from the alpha value of the portion of the trench region 30 adjacent to the transition region 20, such as the portion of the relative refractive index profile Δ3(r) from radial position R₂ to radial position R_{Δ3MIN} or R₃.

In some embodiments, the alpha value of the transition region 20 may be greater than or equal to 0.7 and less than or equal to 1.7—including all sub-ranges or values therebetween. For example, in some embodiments, the alpha value of the transition region 20 may be greater than or equal to 0.7 and less than or equal to 1.7, greater than or equal to 0.7 and less than or equal to 1.5, greater than or equal to 0.7 and less than or equal to 1.3, greater than or equal to 0.7 and less than or equal to 1.1, greater than or equal to 0.7 and less than or equal to 0.9, greater than or equal to 0.9 and less than or equal to 1.7, greater than or equal to 0.9 and less than or equal to 1.5, greater than or equal to 0.9 and less than or equal to 1.3, greater than or equal to 0.9 and less than or equal to 1.1, greater than or equal to 1.1 and less than or equal to 1.7, greater than or equal to 1.1 and less than or equal to 1.5, greater than or equal to 1.1 and less than or equal to 1.3, greater than or equal to 1.3 and less than or equal to 1.7, greater than or equal to 1.3 and less than or equal to 1.5, or greater than or equal to 1.5 and less than or equal to 1.7.

In some embodiments, the transition region 20 may include a width W₂ in radial direction (W₂=|R₂−R₁|) that may be less than or equal to 2 μm, less than or equal to 1.75 μm, less than or equal to 1.5 μm, less than or equal to 1.25 μm, less than or equal to 1 μm, less than or equal to 0.75 μm, less than or equal to 0.5 μm, less than or equal to 0.25 μm, or less. As the width W₂ of the transition region 20 decreases, the transition region 20 may resemble an inflection point between the core 10 and the trench region 30. As the width W₂ of the transition region 20 increases, the transition region 20 may represent a gradual transition, e.g., a rounded step, between the core 10 and the trench region 30.

The width W₂ of the transition region 20 may vary as the multimode optical fiber 100 may be optimized for use at different wavelengths with desired bandwidths and/or bend loss performance. For example, in some embodiments, when optimized for used at about 850 nm, the width W₂ of the transition region 20 may be greater than or equal to 0 μm and less than or equal to 1.0 μm, greater than or equal to 0 μm and less than or equal to 0.75 μm, greater than or equal to 0 μm and less than or equal to 0.5 μm, greater than or equal to 0 μm and less than or equal to 0.25 μm, greater than or equal to 0.25 μm and less than or equal to 1.0 μm, greater than or equal to 0.25 μm and less than or equal to 0.75 μm, greater than or equal to 0.25 μm and less than or equal to 0.5 μm, greater than or equal to 0.5 μm and less than or equal to 1.0 μm, greater than or equal to 0.5 μm and less than or equal to 0.75 μm, or greater than or equal to 0.75 μm and less than or equal to 1.0 μm.

In some embodiments, when optimized for use at about 1060 nm, the width W₂ of the transition region 20 may be greater than or equal to 0.2 μm and less than or equal to 0.8 μm, greater than or equal to 0.4 μm and less than or equal to 0.8 μm, greater than or equal to 0.6 Δm and less than or equal to 0.8 μm, greater than or equal to 0.2 μm and less than or equal to 0.6 μm, greater than or equal to 0.4 μm and less than or equal to 0.6 μm, or greater than or equal to 0.2 Δm and less than or equal to 0.4 μm.

In some embodiments, when optimized for use at about 1310 nm, the width W₂ of the transition region 20 may be greater than or equal to 0.2 μm and less than or equal to 0.8 μm, greater than or equal to 0.4 μm and less than or equal to 0.8 μm, greater than or equal to 0.6 Δm and less than or equal to 0.8 μm, greater than or equal to 0.2 μm and less than or equal to 0.6 μm, greater than or equal to 0.4 μm and less than or equal to 0.6 μm, or greater than or equal to 0.2 Δm and less than or equal to 0.4 μm.

In some embodiments, the transition region 20 may include silica. The transition region 20 may be substantially undoped with either fluorine or germania, although the transition region 20 may contain some amount of fluorine, germania, or other dopants due to diffusion from the core 10 and/or the trench region 30.

The outer cladding region 40 may include a relative refractive index profile Δ4(r). In some embodiments, the relative refractive index profile Δ4(r) may be greater than or equal to −0.2% and less than or equal to 0.2%, greater than or equal to −0.15% and less than or equal to 0.15%, greater than or equal to −0.10% and less than or equal to 0.10%, or greater than or equal to −0.05% and less than or equal to 0.05%. In some embodiments, the outer cladding region 40 may have a substantially constant relative refractive index profile, as shown in FIG. 2 with a constant Δ4(r). In some embodiments, Δ4(r)=0%. The outer radius R₄ of the outer cladding region 40 may be greater than or equal to 60 μm and less than or equal to 65 Δm-including all sub-ranges or values therebetween, such as about 62.5 Δm or between about 62.0 μm and 63.0 μm. The outer radius R₄ of the outer cladding region 40 may be greater than or equal to 60 μm, greater than or equal to 61 μm, greater than or equal to 62 μm, or greater. The outer radius R₄ of the outer cladding region 40 may be less than or equal to 65 μm, less than or equal to 64 μm, less than or equal to 63 μm, or less.

In some embodiments, the outer cladding region 40 may include substantially undoped silica, although the silica may contain some amount of chlorine, fluorine, germania, or other dopants in concentrations that collectively do not significantly modify the refractive index of the outer cladding region 40.

The multimode optical fibers described herein may enable high modal bandwidth while still providing superior bend performance.

In some embodiments, the multimode optical fibers described herein may provide an overfilled (OFL) bandwidth at the wavelength of 850 nm that may be greater than or equal to 3.0 GHz-km, greater than or equal to 3.5 GHz-km, greater than or equal to 4.0 GHz-km, greater than or equal to 4.5 GHz-km, greater than or equal to 5.0 GHz-km, greater than or equal to 5.5 GHz-km, greater than or equal to 6.0 GHz-km, greater than or equal to 6.5 GHz-km, greater than or equal to 7.0 GHz-km, greater than or equal to 7.5 GHz-km, greater than or equal to 8.0 GHz-km, greater than or equal to 8.5 GHz-km, greater than or equal to 9.0 GHz-km, greater than or equal to 9.5 GHz-km, greater than or equal to 10.0 GHz-km, greater than or equal to 10.5 GHz-km, or greater.

A minimum calculated effective modal bandwidth (minEMBc) of the multimode optical fibers described herein at the wavelength of 850 nm may be greater than or equal to 4.0 GHz-km, greater than or equal to 6.0 GHz-km, greater than or equal to 8.0 GHz-km, greater than or equal to 10.0 GHz-km, greater than or equal to 12.0 GHz-km, greater than or equal to 14.0 GHz-km, greater than or equal to 16.0 GHz-km, greater than or equal to 18.0 GHz-km, greater than or equal to 20.0 GHz-km, greater than or equal to 22.0 GHz-km, greater than or equal to 24.0 GHZ-km, or greater.

In some embodiments, the multimode optical fibers described herein may provide an OFL bandwidth at the wavelength of 1060 nm greater than or equal to 6.0 GHz-km, greater than or equal to 8.0 GHz-km, greater than or equal to 10.0 GHz-km, greater than or equal to 12.0 GHz-km, greater than or equal to 14.0 GHz-km, greater than or equal to 16.0 GHz-km, greater than or equal to 18.0 GHz-km, greater than or equal to 20.0 GHz-km, greater than or equal to 22.0 GHz-km, greater than or equal to 24.0 GHz-km, greater than or equal to 26.0 GHz-km, greater than or equal to 28.0 GHz-km, greater than or equal to 30.0 GHz-km, greater than or equal to 32.0 GHz-km, greater than or equal to 34.0 GHz-km, greater than or equal to 36.0 GHz-km, or greater.

A minimum calculated effective modal bandwidth (minEMBc) of the multimode optical fibers described herein at the wavelength of 1060 nm may be greater than or equal to 4.0 GHz-km, greater than or equal to 6.0 GHz-km, greater than or equal to 8.0 GHz-km, greater than or equal to 10.0 GHz-km, greater than or equal to 12.0 GHz-km, greater than or equal to 14.0 GHZ-km, greater than or equal to16.0 GHz-km, greater than or equal to 18.0 GHz-km, greater than or equal to 20.0 GHz-km, greater than or equal to 22.0 GHz-km, greater than or equal to 24.0 GHz-km, greater than or equal to 26.0 GHz-km, greater than or equal to 28.0 GHz-km, greater than or equal to 30.0 GHz-km, or greater.

In some embodiments, the multimode optical fibers described herein may provide an OFL bandwidth at the wavelength of 1310 nm greater than or equal to 6.0 GHz-km, greater than or equal to 8.0 GHz-km, greater than or equal to 10.0 GHz-km, greater than or equal to 12.0 GHz-km, greater than or equal to 14.0 GHz-km, greater than or equal to 16.0 GHz-km, greater than or equal to 18.0 GHz-km, greater than or equal to 20.0 GHz-km, greater than or equal to 22.0 GHZ-km, greater than or equal to 24.0 GHz-km, or greater.

A minimum calculated effective modal bandwidth (minEMBc) of the multimode optical fibers described herein at the wavelength of 1310 nm may be greater than or equal to 4.0 GHz-km, greater than or equal to 6.0 GHz-km, greater than or equal to 8.0 GHz-km, greater than or equal to 10.0 GHz-km, greater than or equal to 12.0 GHz-km, greater than or equal to 14.0 GHz-km, greater than or equal to 16.0 GHz-km, greater than or equal to 18.0 GHz-km, greater than or equal to 20.0 GHz-km, greater than or equal to 22.0 GHz-km, or greater.

The multimode optical fibers described herein may achieve the high bandwidths while also providing excellent bend performance. For example, the multimode optical fibers described herein may achieve a 2×15 mm diameter mandrel wrap attenuation increase at the wavelength of 850 nm that may be less than or equal to 0.1 dB/turn, less than or equal to 0.09 dB/turn, less than or equal to 0.08 dB/turn, less than or equal to 0.07 dB/turn, less than or equal to 0.06 dB/turn, less than or equal to 0.05 dB/turn, less than or equal to 0.04 dB/turn, less than or equal to 0.03 dB/turn, less than or equal to 0.02 dB/turn, less than or equal to 0.01 dB/turn, less than or equal to 0.005 dB/turn, or less.

The multimode optical fibers described herein may achieve the high bandwidths while also providing a 2×15 mm diameter mandrel wrap attenuation increase at the wavelength of 1310 nm that may be less than or equal to 0.3 dB/turn, less than or equal to 0.25 dB/turn, less than or equal to 0.2 dB/turn, less than or equal to 0.15 dB/turn, less than or equal to 0.1 dB/turn, less than or equal to 0.09 dB/turn, less than or equal to 0.08 dB/turn, less than or equal to 0.07 dB/turn, less than or equal to 0.06 dB/turn, less than or equal to 0.05 dB/turn, less than or equal to 0.04 dB/turn, less than or equal to 0.03 dB/turn, less than or equal to 0.02 dB/turn, less than or equal to 0.01 dB/turn, or less.

In some embodiments, the multimode optical fibers described herein may exhibit a numerical aperture greater than or equal to 0.195, greater than or equal to 0.200, greater than or equal to 0.205, greater than or equal to 0.210, greater than or equal to 0.215, greater than or equal to 0.220, or greater. In some embodiments, the multimode optical fibers described herein may exhibit a numerical aperture less than or equal to 0.225, less than or equal to 0.220, less than or equal to 0.215, less than or equal to 0.210, less than or equal to 0.205, less than or equal to 0.200, or less.

In some embodiments, the multimode optical fibers described herein may exhibit a numerical aperture greater than or equal to 0.195 and less than or equal to 0.225—including all sub-ranges or values therebetween. For example, in some embodiments, the multimode optical fibers described herein may exhibit a numerical aperture greater than or equal to 0.195 and less than or equal to 0.225, greater than or equal to 0.195 and less than or equal to 0.220, greater than or equal to 0.195 and less than or equal to 0.215, greater than or equal to 0.195 and less than or equal to 0.210, greater than or equal to 0.195 and less than or equal to 0.205, greater than or equal to 0.195 and less than or equal to 0.200, greater than or equal to 0.200 and less than or equal to 0.225, greater than or equal to 0.200 and less than or equal to 0.220, greater than or equal to 0.200 and less than or equal to 0.215, greater than or equal to 0.200 and less than or equal to 0.210, greater than or equal to 0.200 and less than or equal to 0.205, greater than or equal to 0.205 and less than or equal to 0.225, greater than or equal to 0.205 and less than or equal to 0.220, greater than or equal to 0.205 and less than or equal to 0.215, greater than or equal to 0.205 and less than or equal to 0.210, greater than or equal to 0.210 and less than or equal to 0.225, greater than or equal to 0.210 and less than or equal to 0.220, greater than or equal to 0.210 and less than or equal to 0.215, greater than or equal to 0.215 and less than or equal to 0.225, greater than or equal to 0.215 and less than or equal to 0.220, or greater than or equal to 0.220 and less than or equal to 0.225.

In some embodiments, the optical core diameter of the multimode optical fibers described herein may be greater than or equal to 48 μm, greater than or equal to 49 μm, greater than or equal to 50 μm, greater than or equal to 51 μm. In some embodiments, the optical core diameter of the multimode optical fibers described herein may be less than or equal to 52 μm, less than or equal to 51 μm, or less than or equal to 50 μm.

In some embodiments, the optical core diameter of the multimode optical fibers described herein may be greater than or equal to 48 μm and less than or equal to 54 Δm-including all sub-ranges or values therebetween. For example, in some embodiments, the optical core diameter of the multimode optical fibers described herein may be greater than or equal to 48 μm and less than or equal to 54 μm, greater than or equal to 48 μm and less than or equal to 53 μm, greater than or equal to 48 μm and less than or equal to 52 μm, greater than or equal to 48 μm and less than or equal to 51 μm, greater than or equal to 48 μm and less than or equal to 50 μm, greater than or equal to 49 μm and less than or equal to 54 μm, greater than or equal to 49 μm and less than or equal to 53 μm, greater than or equal to 49 μm and less than or equal to 52 μm, greater than or equal to 49 μm and less than or equal to 51 μm, greater than or equal to 49 μm and less than or equal to 50 μm, greater than or equal to 50 μm and less than or equal to 54 μm, greater than or equal to 50 μm and less than or equal to 53 μm, greater than or equal to 50 μm and less than or equal to 52 μm, greater than or equal to 50 μm and less than or equal to 51 μm, greater than or equal to 51 μm and less than or equal to 54 μm, greater than or equal to 51 μm and less than or equal to 53 μm, or greater than or equal to 51 μm and less than or equal to 52 μm.

The fibers disclosed herein may be drawn from optical fiber preforms made using manufacturing techniques and fiber draw methods and apparatus, for example, as disclosed in U.S. Pat. No. 10,131,566B2, the specification of which is hereby incorporated by reference. The designs of the fibers described herein allow for simpler manufacturing process to be utilized as compared to some of the multi-step processes that may be required for making fluorine index trench, while still achieving excellent bend performance, bandwidth, etc.

### EXAMPLES

Various exemplary embodiments will be further clarified by the following examples. It will be apparent to those skilled in the art that various modifications and variations can be made without departing from the spirit or scope of the claims.

Set forth below in Table 1 are a variety of modeled examples of multimode optical fibers, as well as properties, according to some embodiments. Examples 1 through 10 in Table 1 are optimized for use at 850 nm, with minimum calculated effective modal bandwidth minEMBc values greater than 4160 MHz-km (4.16 GHz-km) at 850 nm.

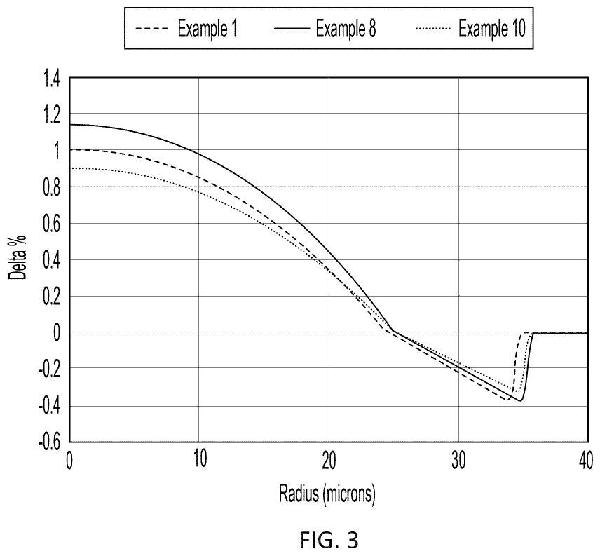

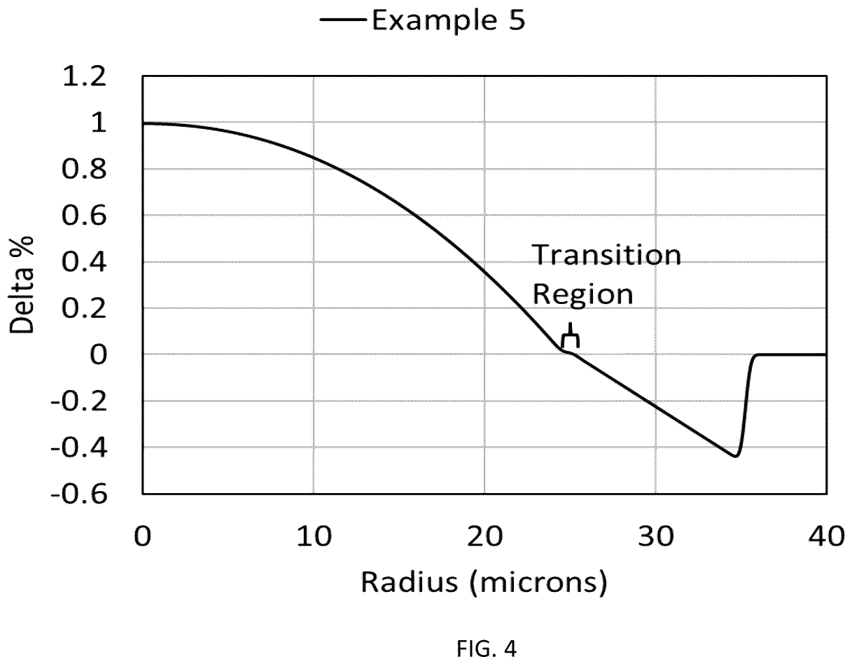

The relative refractive index profiles of examples 1 through 10 include a graded index core surrounded by a triangular trench separated from the core by a transition region. FIG. 3 shows the relative refractive index profiles of examples 1, 8, and 10. FIG. 4 shows the relative refractive index profile of example 5. As more clearly shown in FIG. 4, the transition region of the relative refractive index profile of example 5 includes a relatively small negative slope between the graded index core and the triangular trench. The transition regions of examples 1 through 10 have widths between 0 and 1.0 μm, with lower values resembling an inflection point and higher values a rounded step. The trench volumes of examples 1 through 10 have values between-100%-microns² and −170%-microns². The cores of examples 1 through 10 have alpha values between 2.10 and 2.14.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Δ1_{MAX} (%) | 1.01 | 1.00 | 1.05 | 1.04 | 0.99 | 1.00 | 1.08 | 1.14 | 0.94 | 0.90 |
| R₁ (μm) | 24.26 | 25.08 | 24.61 | 24.98 | 24.53 | 24.52 | 24.61 | 25.08 | 24.91 | 24.99 |
| Core Alpha | 2.122 | 2.122 | 2.118 | 2.120 | 2.124 | 2.134 | 2.122 | 2.122 | 2.119 | 2.118 |
| R₂ (μm) | 24.63 | 25.24 | 25.53 | 25.61 | 25.24 | 25.45 | 24.73 | 25.24 | 25.16 | 25.08 |
| W₂ (μm) | 0.37 | 0.17 | 0.92 | 0.64 | 0.71 | 0.93 | 0.12 | 0.17 | 0.25 | 0.09 |
| Δ3_{MIN} (%) | −0.39 | −0.40 | −0.35 | −0.36 | −0.47 | −0.48 | −0.39 | −0.40 | −0.39 | −0.35 |
| R₃ (μm) | 34.43 | 35.38 | 35.47 | 35.71 | 35.25 | 35.71 | 34.68 | 35.38 | 35.22 | 35.18 |
| R_{D3MIN} (μm) | 33.83 | 34.78 | 34.87 | 35.11 | 34.65 | 35.11 | 34.08 | 34.78 | 34.62 | 34.58 |
| V₃ (%-microns²) | −120.4 | −130.1 | −112.9 | −118.7 | −150.0 | −160.7 | −122.7 | −130.1 | −125.4 | −112.4 |
| OFL Bandwidth at | 8.41 | 7.52 | 3.54 | 5.47 | 6.74 | 4.45 | 9.42 | 7.31 | 8.75 | 7.69 |
| 850 nm (GHz-km) | | | | | | | | | | |
| minEMBc at 850 | 20.09 | 17.70 | 8.16 | 13.25 | 16.30 | 10.90 | 22.04 | 17.49 | 21.56 | 19.02 |
| nm (GHz-km) | | | | | | | | | | |
| Numerical | 0.208 | 0.207 | 0.212 | 0.211 | 0.207 | 0.207 | 0.216 | 0.221 | 0.201 | 0.197 |
| Aperture | | | | | | | | | | |
| Optical Core | 49.98 | 51.66 | 50.69 | 51.45 | 50.54 | 50.51 | 50.71 | 51.66 | 51.31 | 51.48 |
| Diameter | | | | | | | | | | |
| 2 × 15 mm diameter | 0.02 | 0.02 | 0.02 | 0.02 | 0.01 | 0.01 | 0.01 | 0.01 | 0.04 | 0.06 |
| bend loss 850 nm | | | | | | | | | | |
| 2 × 15 mm diameter | 0.13 | 0.12 | 0.13 | 0.12 | 0.08 | 0.05 | 0.08 | 0.03 | 0.16 | 0.22 |
| bend loss 1310 nm | | | | | | | | | | |

Set forth below in Table 2 are additional modeled examples of multimode optical fibers, as well as properties, according to some embodiments. Examples 11 through 14 in Table 2 are optimized for use at 1060 nm, with minimum calculated effective modal bandwidth minEMBc values greater than 4160 MHz-km (4.16 GHz-km) at 1060 nm.

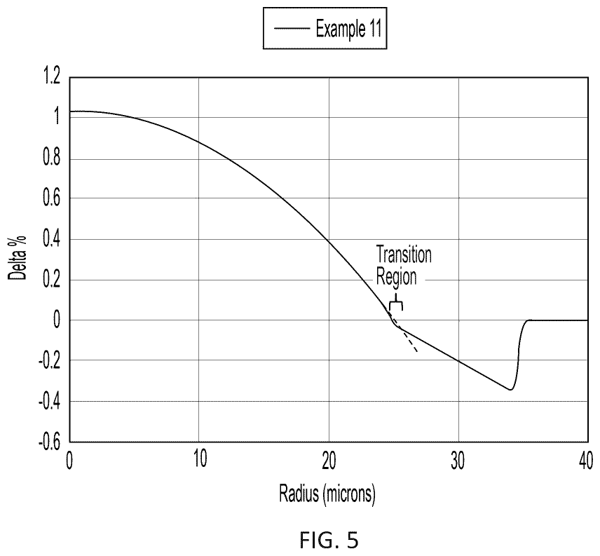

The relative refractive index profiles of examples 11 through 14 include a graded index core surrounded by a triangular trench separated from the core by a transition region. FIG. 5 shows the relative refractive index profile of example 11 (optimized for 1060 nm). As shown in FIG. 5, the transition region truncates the alpha profile of the graded index core, with the extension of the alpha profile of the graded index core shown in dash. The transition region corresponds to the truncation of the alpha profile of the graded index core by 0.2 μm to 0.8 μm. The transition region may resemble a small step, at the interface between the graded index core and the triangular trench. The trench volumes of examples 11 through 14 have values between −100%-microns² and −140%-microns². The cores of examples 11 through 14 have alpha values between 2.04 and 2.08.

TABLE 2

| | Ex. 11 | Ex. 12 | Ex. 13 | Ex. 14 |
|---|---|---|---|---|
| Δ1_{MAX} (%) | 1.04 | 1.01 | 0.99 | 0.99 |
| R₁ (μm) | 24.91 | 24.79 | 24.86 | 25.13 |
| Core Alpha | 2.065 | 2.066 | 2.066 | 2.066 |
| R₂ (μm) | 24.50 | 24.45 | 24.62 | 25.34 |
| W₂ (μm) | 0.41 | 0.34 | 0.24 | 0.21 |
| Δ3_{MIN} (%) | −0.36 | −0.39 | −0.41 | −0.42 |
| R₃ (μm) | 34.57 | 34.46 | 34.66 | 35.49 |
| R_{Δ3MIN} (μm) | 33.97 | 33.86 | 34.06 | 34.89 |
| V₃ (%-microns²) | −113.81 | −120.94 | −129.40 | −135.35 |
| OFL Bandwidth at 1060 | 34.08 | 24.52 | 15.55 | 6.58 |
| nm (GHz-km) | | | | |
| minEMBc at 1060 nm | 27.46 | 24.82 | 15.64 | 6.82 |
| (GHz-km) | | | | |
| Numerical Aperture | 0.211 | 0.208 | 0.206 | 0.206 |
| Optical Core Diameter | 51.31 | 51.06 | 51.20 | 51.76 |
| 2 × 15 mm diameter | 0.02 | 0.02 | 0.02 | 0.02 |
| bend loss 850 nm | | | | |
| 2 × 15 mm diameter | 0.13 | 0.13 | 0.12 | 0.11 |
| bend loss 1310 nm | | | | |

Set forth below in Table 3 are further modeled examples of multimode optical fibers, as well as properties, according to some embodiments. Examples 15 through 18 in Table 3 are optimized for use at 1310 nm, with minimum calculated effective modal bandwidth minEMBc values greater than 4160 MHz-km (4.16 GHz-km) at 1310 nm.

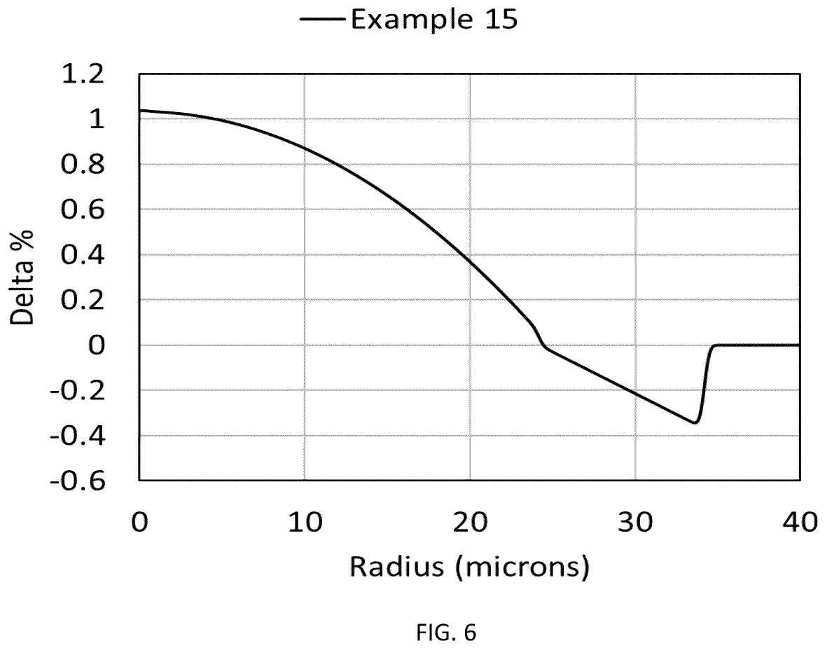

The relative refractive index profiles of examples 15 through 18 include a graded index core surrounded by a triangular trench separated from the core by a transition region. FIG. 6 shows the relative refractive index profile of example 15 (optimized for 1310 nm). As shown in FIG. 6, the transition region truncates the alpha profile of the graded index core. The transition region corresponds to the truncation of the alpha profile of the graded index core by 0.2 μm to 0.8 μm. The transition region may resemble a small step at the interface between the graded index core and the triangular trench. The trench volumes of examples 15 through 18 have values between-100%-microns² and −140%-microns². The cores of examples 15 through 18 have alpha values between 2.00 and 2.04.

TABLE 3

| | Ex. 15 | Ex. 16 | Ex. 17 | Ex. 18 |
|---|---|---|---|---|
| Δ1_{MAX} (%) | 1.03 | 1.00 | 1.00 | 0.99 |
| R₁ (μm) | 24.72 | 24.96 | 25.01 | 25.21 |
| Core Alpha | 2.025 | 2.025 | 2.026 | 2.016 |
| R₂ (μm) | 24.18 | 24.45 | 24.59 | 24.60 |
| W₂ (μm) | 0.55 | 0.51 | 0.42 | 0.61 |
| Δ3_{MIN} (%) | −0.37 | −0.41 | −0.40 | −0.41 |
| R₃ (μm) | 34.17 | 34.54 | 34.69 | 34.78 |
| R_{Δ3MIN} (μm) | 33.57 | 33.94 | 34.09 | 34.18 |
| V₃ (%-microns²) | −113.30 | −127.39 | −125.19 | −132.09 |
| OFL Bandwidth at 1310 | 19.98 | 21.75 | 11.91 | 8.00 |
| nm (GHz-km) | | | | |
| minEMBc at 1310 nm | 20.11 | 19.74 | 12.26 | 7.32 |
| (GHz-km) | | | | |
| Numerical Aperture | 0.210 | 0.206 | 0.207 | 0.205 |
| Optical Core Diameter | 50.93 | 51.42 | 51.52 | 51.93 |
| 2 × 15 mm diameter | 0.02 | 0.02 | 0.02 | 0.02 |
| bend loss 850 nm | | | | |
| 2 × 15 mm diameter | 0.14 | 0.12 | 0.13 | 0.12 |
| bend loss 1310 nm | | | | |

Set forth below in Table 4 are further modeled examples of multimode optical fibers, as well as properties, according to some embodiments. Examples P011, P012, and P013 include similar or substantially the same trench volumes V₃, but the depths and widths of the respective trench regions may be varied to accommodate different process conditions while still achieve desired bend loss performance.

TABLE 4

| | P011 | P012 | P013 |
|---|---|---|---|
| Δ1_{MAX} (%) | 0.974 | 0.974 | 0.974 |
| Core Alpha | 2.12 | 2.12 | 2.12 |
| R₁ (μm) | 24.05 | 24.05 | 24.05 |
| R₂ (μm) | 24.235 | 24.235 | 24.235 |
| R₃ (μm) | 35.15 | 33.485 | 31.82 |
| R_{Δ3MIN} (μm) | 35.15 | 33.485 | 31.82 |
| Δ3_{MIN} (%) | −0.3894 | −0.5 | −0.615 |
| V₃ (%-microns²) | 136.47 | 140.27 | 143.71 |
| Numerical Aperture | 0.2006 | 0.2009 | 0.2012 |
| 2 × 15 mm diameter | 0.02 | 0.02 | 0.01 |
| bend loss 850 nm* | | | |
| 2 × 15 mm diameter | 0.12 | 0.11 | 0.10 |
| bend loss 1310 nm* | | | |

*Assuming 50 μm nominal core diameter.

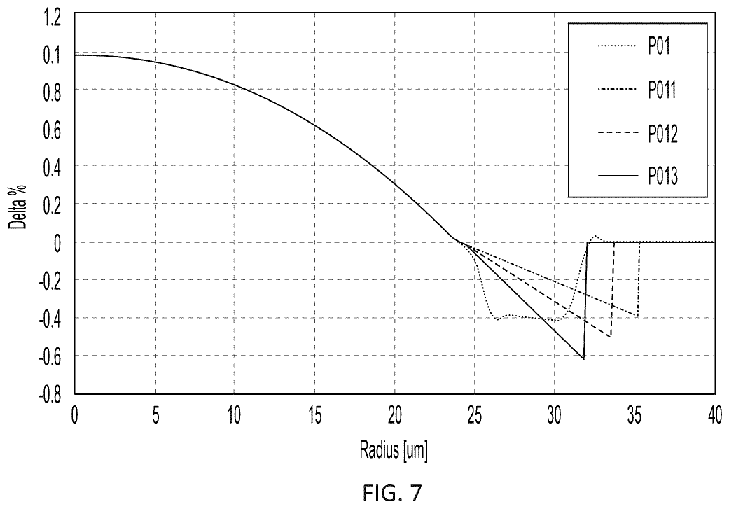

FIG. 7 shows relative refractive index profiles of examples P011, P012, and P013 with triangular trenches, as well as a measured refractive index profile of an OM4 fiber P01 with a depressed index trench region having a substantially square trench.

Set forth below in Table 5 are modeled bandwidth values for examples P011, P012, P013 of Table 4, as well as the OM4 fiber P01 shown in FIG. 7. As shown in Table 5, the multimode optical fibers having a triangular trench described herein are capable of exhibiting greater bandwidths than the OM4 fiber with a depressed index trench region.

TABLE 5

| | P01 | P011 | P012 | P013 |
|---|---|---|---|---|
| OFL (GHz-km) | 4.48 | 5.30 | 7.52 | 6.04 |
| EMB1 (GHz-km) | 5.50 | 5.53 | 5.56 | 5.57 |
| EMB2 (GHz-km) | 6.14 | 6.25 | 6.77 | 6.58 |
| EMB3 (GHz-km) | 11.13 | 11.45 | 11.45 | 11.23 |
| EMB4 (GHz-km) | 6.36 | 9.25 | 9.78 | 8.41 |
| EMB5 (GHz-km) | 6.17 | 9.80 | 9.83 | 8.31 |
| EMB6 (GHz-km) | 5.03 | 6.01 | 7.82 | 6.97 |
| EMB7 (GHz-km) | 5.70 | 7.20 | 7.88 | 7.17 |
| EMB8 (GHz-km) | 6.28 | 6.69 | 7.10 | 6.80 |
| EMB9 (GHz-km) | 7.08 | 8.74 | 9.05 | 8.09 |
| EMB10 (GHz-km) | 7.15 | 8.29 | 8.30 | 7.81 |
| minEMBc (GHz-km) | 5.03 | 6.01 | 6.77 | 6.58 |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multimode optical fiber, comprising:
a core comprising:
a radius R₁ that is greater than or equal to 23 μm and less than or equal to 27 μm; and
a graded index having an alpha value that is greater than or equal to 1.9 and less than or equal to 2.2;
a trench region having a triangular relative refractive index profile, the trench region comprising:
at least one portion within which a relative refractive index delta percent of the trench region continuously decreases with increasing radius; and
a trench volume V₃ ranging from −100%-microns² to −170%-microns²; and
a transition region disposed between the core and the at least one portion of the trench region, wherein an alpha value of the transition region is different from the alpha value of the core, and wherein the alpha value of the transition region is different from an alpha value of the at least one portion of the trench region;
wherein a minimum calculated effective modal bandwidth (minEMBc) of the multimode optical fiber at 850 nm is greater than or equal to 4.0 GHz-km; and
wherein an overfilled (OFL) bandwidth of the multimode optical fiber at 850 nm is greater than or equal to 3.0 GHz-km.

2. The multimode optical fiber of claim 1, wherein the alpha value of the transition region is greater than or equal to 0.7 and less than or equal to 1.7.

3. The multimode optical fiber of claim 1, wherein the transition region includes a width that is less than or equal to 2 μm.

4. The multimode optical fiber of claim 1, wherein the relative refractive index delta percent of the trench region decreases linearly within the at least one portion of the trench region.

5. The multimode optical fiber of claim 1, wherein the alpha value of the at least one portion of the trench region is greater than or equal to 0.8 and less than or equal to 1.2, or wherein the alpha value of the at least one portion of the trench region is about 1.

6. The multimode optical fiber of claim 1, wherein the alpha value of the graded index core is greater than or equal to 2.10 and less than or equal to 2.14.

7. The multimode optical fiber of claim 1, wherein the multimode optical fiber exhibits a 2×15 mm diameter mandrel wrap attenuation increase that is less than or equal to 0.1 dB/turn at 850 nm.

8. The multimode optical fiber of claim 1, wherein the multimode optical fiber exhibits a 2×15 mm diameter mandrel wrap attenuation increase that is less than or equal to 0.3 dB/turn at 1310 nm.

9. The multimode optical fiber of claim 1, wherein the multimode optical fiber exhibits a numerical aperture greater than or equal to 0.195 and less than or equal to 0.225.

10. The multimode optical fiber of claim 1, wherein the trench region comprises a minimum relative refractive index delta percent Δ3_{MIN} that is greater than or equal to −0.5% and less than or equal to −0.3%.

11. The multimode optical fiber of claim 1, wherein the core comprises a maximum relative refractive index delta percent Δ1_{MAX} that is greater than or equal to 0.6% and less than or equal to 1.4%.

12. A multimode optical fiber, comprising:
a core comprising:
a radius R₁ that is greater than or equal to 23 μm and less than or equal to 27 μm; and
a graded index having an alpha value that is greater than or equal to 1.9 and less than or equal to 2.2;
a trench region comprising:
at least one portion within which a relative refractive index delta percent of the trench region continuously decreases in a substantially linear manner; and
a trench volume V₃ ranging from −100%-microns² to −170%-microns²; and
a transition region disposed between the core and the at least one portion of the trench region, the transition region comprising:
an alpha value greater than or equal to 0.7 and less than or equal to 1.7, wherein the alpha value of the transition region is different from the alpha value of the core, and wherein the alpha value of the transition region is different from an alpha value of the at least one portion of the trench region.

13. The multimode optical fiber of claim 12, wherein the alpha value of the at least one portion of the trench region is greater than or equal to 0.8 and less than or equal to 1.2.

14. The multimode optical fiber of claim 12, wherein a width of the transition region is less than or equal to 2 μm.

15. The multimode optical fiber of claim 12, wherein:
the alpha value of the graded index core is greater than or equal to 2.10 and less than or equal to 2.14;
the multimode optical fiber exhibits an overfilled (OFL) bandwidth greater than or equal to 3.0 GHz-km at 850 nm; and
the minimum calculated effective modal bandwidth (minEMBc) of the multimode optical fiber is greater than or equal to 4.0 GHz-km at 850 nm.

16. The multimode optical fiber of claim 12, wherein:
the alpha value of the graded index core is greater than or equal to 2.04 and less than or equal to 2.08;
the multimode optical fiber exhibits an overfilled (OFL) bandwidth greater than or equal to 6.0 GHz-km at 1060 nm; and
the minimum calculated effective modal bandwidth (minEMBc) of the multimode optical fiber is greater than or equal to 4.0 GHz-km at 1060 nm.

17. The multimode optical fiber of claim 12, wherein:
the alpha value of the graded index core is greater than or equal to 2.00 and less than or equal to 2.04;
the multimode optical fiber exhibits an overfilled (OFL) bandwidth greater than or equal to 6.0 GHz-km at 1310 nm; and
the minimum calculated effective modal bandwidth (minEMBc) of the multimode optical fiber is greater than or equal to 4.0 GHz-km at 1310 nm.

18. The multimode optical fiber of claim 12, wherein the trench region comprises a trench volume V₃ ranging from −100%-microns² to −140%-microns².

19. The multimode optical fiber of claim 12, wherein:
the multimode optical fiber exhibits a 2×15 mm diameter mandrel wrap attenuation increase that is less than or equal to 0.3 dB/turn at 1310 nm; and
the multimode optical fiber exhibits a 2×15 mm diameter mandrel wrap attenuation increase that is less than or equal to 0.1 dB/turn at 850 nm.

20. A multimode optical fiber, comprising:
a core comprising:
a radius R₁ that is greater than or equal to 23 μm and less than or equal to 27 μm; and
a graded index having an alpha value that is greater than or equal to 1.9 and less than or equal to 2.2;
a trench region having a triangular relative refractive index profile, the trench region comprising:
at least one portion within which a relative refractive index delta percent of the trench region continuously decreases with increasing radius; and
a trench volume V₃ ranging from −100%-microns² to −170%-microns²; and
wherein a minimum calculated effective modal bandwidth (minEMBc) of the multimode optical fiber at 850 nm is greater than or equal to 4.0 GHz-km; and
wherein an overfilled (OFL) bandwidth of the multimode optical fiber at 850 nm is greater than or equal to 3.0 GHz-km.
